(19) United States
(12) Patent Application Publication
(10) Pub. No.: US 2024/0382289 A1
(43) Pub. Date: Nov. 21, 2024

(54) BONE SCREW FOR 3D GUIDED BONE REGENERATION

(71) Applicant: BIOTEM CO., LTD, Busan (KR)

(72) Inventors: Dong Seok SOHN, Daegu (KR); Young Ho LEE, Gyeonggi-do (KR); Koan Young LEE, Gyeonggi-do (KR)

(21) Appl. No.: 18/271,904

(22) PCT Filed: Nov. 25, 2022
(86) PCT No.: PCT/KR2022/018777

§ 371 Date: Jul. 12, 2023

(30) Foreign Application Priority Data
Feb. 15, 2022 (KR) 10-2022-0019358

(51) Int. Cl. A61C 8/02; A61C 8/00

(52) U.S. Cl. CPC A61C 8/0006; A61C 2008/0084

(57) ABSTRACT

Disclosed is a bone screw for 3D guided bone regeneration used in dental surgery for inducing and regenerating a part of alveolar bone defected in or around an implant surgery region. The bone screw includes: a head portion configured to provide a tenting function for a part of the alveolar bone to be regenerated or induced; a neck portion formed on a lower surface of the head portion; a screw portion formed beneath the neck portion and directly fixed to the alveolar bone in a thread fastening manner, wherein the alveolar bone can be induced or regenerated three-dimensionally. Since osteoinduction is promoted three-dimensionally to grow the alveolar bone rapidly by filling the bone graft, it is possible to shorten a period of the dental implant surgery procedure.

### TECHNICAL FIELD

The present invention relates to a bone screw, and particularly, to a bone screw for 3D guided bone regeneration to facilitate implant surgery by regenerating alveolar bone rapidly when the amount of the alveolar bone is not sufficient due to a loss of the alveolar bone at or around an implant surgery region.

### BACKGROUND ART

Dental Implant (hereinafter, simply referred to as “implant”) refers to a dental treatment technique or an artificial tooth itself for restoring the function of a natural tooth by implanting the artificial tooth made of a material with excellent biocompatibility (for example, titanium-based metal) to a jawbone where there is a tooth defect or where a tooth was extracted.

Such an implant generally consists of a fixture (implant fixture), an abutment as a connecting member, and an artificial tooth (crown).

The fixture is formed in a screw-like shape with a material having excellent biocompatibility. The fixture is implanted into the alveolar bone where the tooth is defected, and is integrated with the bone. The abutment is a part on which artificial teeth for mastication and aesthetic are mounted on the upper end, and is combined with the lower fixture by means of a thread structure.

For a successful implant surgery, the patient has to have a sufficient amount of alveolar bone in or around a region where the implant is to be placed. However, in many cases, the amount of alveolar bone to accommodate the implant is not sufficient. The reason is as follows. Even quite healthy alveolar bone subjected to the tooth extraction is significantly absorbed when it is exposed for a long period of time. When the cause of tooth extraction is chronic periodontitis, dental trauma, or the like, there are many cases in which a significant amount of alveolar bone has already been lost before the tooth is extracted. Furthermore, in many cases, a defect occurs due to a bony depression originally present in a maxillary anterior region.

Therefore, when the amount of alveolar bone is not sufficient in or around the area where the implant is to be placed, the guided bone regeneration (GBR) is applied to increase the amount of bone tissue to sufficiently envelope the implant before the implant surgery.

The guided bone regeneration is a procedure that promotes bone tissue regeneration by filling bone grafts in a bone defect. More specifically, (referring to some scenes of FIGS. 1 and 3) a gum in the area where bone tissue regeneration is required is incised, and then, the bone graft B is filled in the alveolar bone defect where bone tissue regeneration is required. Thereon, a membrane M is placed, and the incised gum is sutured and maintained for a certain period of time. As a result, the bone graft is integrally combined (osseointegrated) with the alveolar bone defect, and the alveolar bone is regenerated.

In the prior art, before filling the bone graft B in the alveolar bone defect, the implant fixture 1 is vertically installed in the alveolar bone. Then, the bone graft is filled, and the alveolar bone and the fixture 1 are osseointegrated. Then, the abutment 2 is connected thereon, and the artificial tooth (crown, 3) is fixed.

Such a method of the prior art provides a reasonable effect in that the fixture is firmly implanted in the bone tissue. However, there is a limitation that the fixture for which the artificial tooth is to be installed should be installed only in the vertical direction to the alveolar bone. This makes the bone tissue regeneration take a lot of time, so that a considerable period of time is required to complete the implant surgery disadvantageously.

In addition, in the guided bone regeneration of the prior art, when the bone graft is depressed during alveolar bone growth or when pressure is applied to the regenerated bone after the guided bone regeneration, the alveolar bone is not maintained, so that it is difficult to achieve an effective implant surgery procedure disadvantageously.

### DETAILED DESCRIPTION

### Technical Problems

In view of the aforementioned problems of the prior art, an object of the present invention is to provide a bone screw for 3D guided bone regeneration, capable of shortening the implant procedure period, that is directly fixed to the alveolar bone to provide tenting and shielding functions for preventing sinking of the bone graft, and allows the alveolar bone to be fastened not only in the vertical direction but also in the horizontal direction, so that the alveolar bone can grow rapidly while maintaining its three-dimensional shape by filling the bone graft.

### Technical Solutions

In order to address the problems of the prior art described above, according to the present invention, there is provided a bone screw for 3D guided bone regeneration used in dental surgery for inducing and regenerating a part of alveolar bone defected in or around an implant surgery region, the bone screw includes: a head portion configured to provide a tenting function for a part of the alveolar bone to be regenerated or induced; a neck portion formed beneath the head portion; a screw portion formed beneath the neck portion and directly fixed to the alveolar bone in a thread fastening manner, wherein the alveolar bone can be induced or regenerated three-dimensionally.

In addition, the head portion has a plurality of blood holes. Therefore, it is possible to regenerate the alveolar bone more rapidly while blood leaking from a wound region flows through the blood holes.

In the bone screw described above, a ratio between an inner diameter of the screw portion and a diameter of the head portion is set to 1:4 to 1:6, and a ratio between an outer diameter of the screw portion and a diameter of the head portion is set to 1:3 to 1:5.

Furthermore, a wrench hole is provided at the center of the head portion.

### Advantageous Effects

The bone screw for 3D guided bone regeneration according to the present invention configured as described above is directly fixed to the alveolar bone without a separate fixture. Therefore, the bone screw according to the present invention can be fastened to the alveolar bone not only in the vertical direction but also in the horizontal direction. Since osteoinduction is promoted three-dimensionally to grow the alveolar bone rapidly by filling a bone graft in the area where the implant is to be placed or the area where the bone is defected, it is possible to shorten a period of the dental implant surgery procedure.

### BRIEF DESCRIPTION OF THE DRAWINGS

FIG. 1 is a diagram schematically illustrating an implant surgery procedure of the prior art.

FIG. 2 is a diagram illustrating a bone screw for 3D guided bone regeneration according to the present invention.

FIG. 3 is a diagram schematically illustrating a regeneration process of the alveolar bone using the bone screw for 3D guided bone regeneration according to the present invention.

FIGS. 4 and 5 are diagrams schematically illustrating an implant surgery procedure using the bone screw for 3D guided bone regeneration according to the present invention.

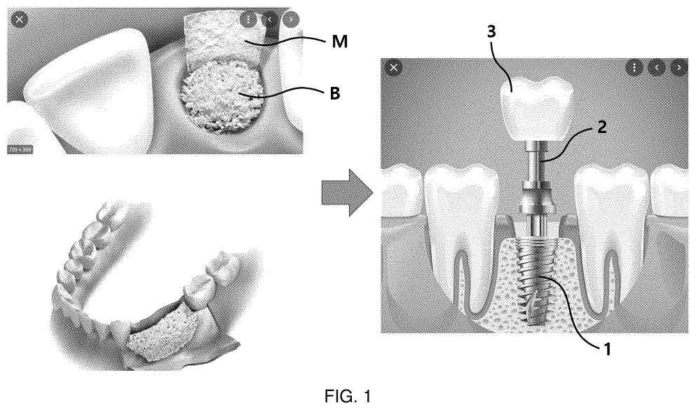

### BEST MODE FOR EMBODYING THE INVENTION

The bone screw for 3D guided bone regeneration according to the present invention is used in a dental implant surgery procedure for osteoinducing and regenerating a defected part of alveolar bone in or around the implant surgery portion. The bone screw according to the present invention includes a head portion that provides a tenting function for the osteoinduced alveolar bone, a neck portion formed on the lower surface of the head portion, and a screw portion formed beneath the neck portion and directly fixed to the alveolar bone in a thread fastening manner. According to the present invention, it is possible to induce and regenerate the alveolar bone three-dimensionally.

### EMBODIMENTS

A bone screw for 3D guided bone regeneration according to the present invention will now be described in detail with reference to the accompanying drawings.

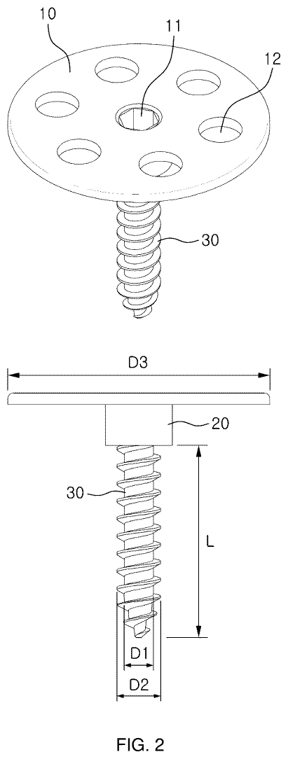

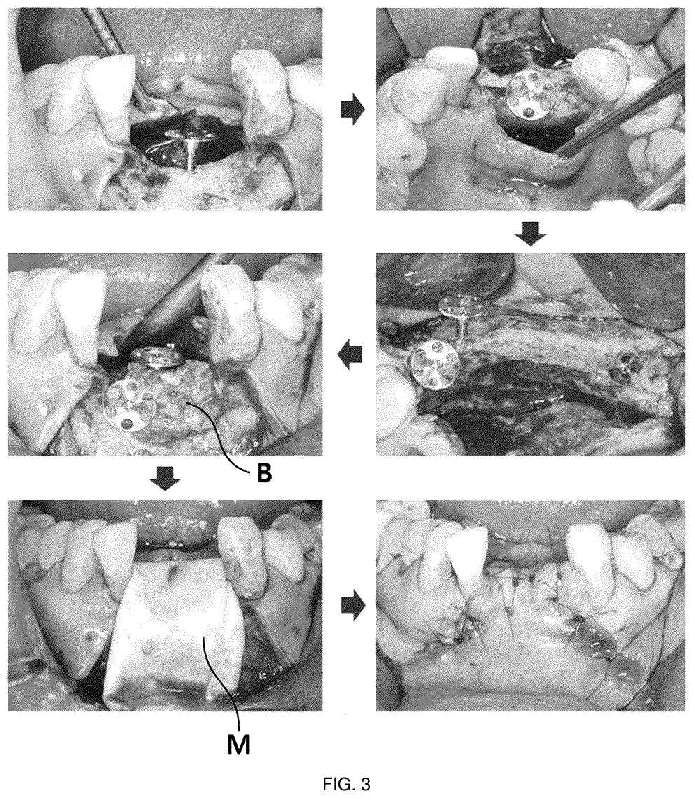

FIG. 2 is a diagram illustrating a bone screw for 3D guided bone regeneration according to the present invention, and FIGS. 3 to 5 are diagrams schematically an implant surgery procedure using the bone screw for 3D guided bone regeneration according to the present invention.

The bone screw for 3D guided bone regeneration according to the present invention is used to fill a bone graft B in the area where the implant is to be placed or fill the bone graft B in a defected bone area around the area where the implant is to be placed.

The bone screw for 3D guided bone regeneration according to the present invention includes a head portion 10, a neck portion 20 integrally formed on the lower surface of the head portion 10, and a screw portion 30 integrally formed beneath the neck portion 20.

The head portion 10 provides tenting and shielding functions, and is formed in a disc shape with a certain diameter. In addition, the head portion 10 has a wrench hole 11 and a plurality of blood holes 12.

When the bone screw is installed in the area where the implant is to be placed, and the bone graft B is filled, the bone graft B is filled up to the bottom of the head portion 10.

The wrench hole 11 is formed in the center of the head portion 10, where the end of the wrench is inserted to rotate the bone screw.

A plurality of blood holes 12 are provided around the wrench hole 11, and the blood leaking from a wound region flows through the blood holes 12 to help the alveolar bone to be regenerated more rapidly.

The neck portion 20 is formed at the center of the lower surface of the head portion 10 with a diameter smaller than that of the head portion 10. The wrench hole 11 provided in the head portion 10 extends up to a certain depth of the neck portion 20 from the head portion 10.

The screw portion 30 is fastened to the alveolar bone in a thread fastening manner to serve as a support. Since such a screw portion 30 can be directly fixed to the alveolar bone and can be fastened in three-dimensional directions including the vertical and horizontal directions of the alveolar bone. As a result, the bone screw according to the present invention can be applied in any of the mesial, facial, and coronal directions of the alveolar bone.

That is, the head portion 10 of the bone screw fastened to the alveolar bone can provide both vertical tenting and side tenting functions on the top and side surfaces. Therefore, it is possible to promote bone regeneration using the bone graft B and more effectively prevent a loss of the filled regeneration space filled with the bone graft B, thereby promoting regeneration of the alveolar bone.

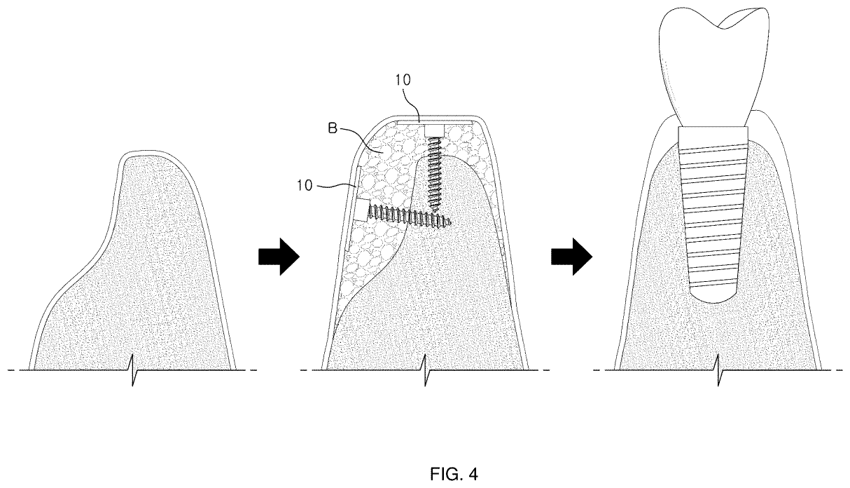

As the alveolar bone is successfully regenerated by installing the bone screws, the bone screws according to the present invention installed on the top and side surfaces of the alveolar bone are removed. Then, a fixture is vertically installed on the top surface of the alveolar bone, where the bone screw was installed, and an abutment and an artificial tooth are installed, so that the implant placement is completed (see FIGS. 3 and 4).

In the prior art, the fixture is installed only vertically on the top surface of the gum (because the artificial tooth is to be installed to the gum in the coronal-apical direction, the fixture cannot be installed in the facial-lingual direction), and the bone graft is filled. When the alveolar bone and the fixture are osseointegrated after a certain period of time, the abutment is combined thereon, and then the crown is fixed. Therefore, in the method of the prior art, the bone screw is not installed in the horizontal direction from the side of the gum to promote alveolar bone regeneration unlike the present invention.

Therefore, compared to the present invention, the method of the prior art takes more time for alveolar bone regeneration, and accordingly, a longer period of time is required for the overall implant procedure disadvantageously. Advantageously, the present invention addresses this problem.

Meanwhile, in order to stably install the bone screws on the top and side surfaces of the gum in consideration of the average alveolar bone condition and size of the patients, according to the present invention, a ratio between the inner diameter D1 of the screw portion 30 and the diameter D3 of the head portion 10 is set to 1:4 to 1:6. In addition, the ratio between the outer diameter D2 of the screw portion 30 and the diameter D3 of the head portion 10 is set to 1:3 to 1:5.

More specifically, the inner diameter D1 of the screw portion 30 is 1.5 mm, the outer diameter D2 is 1.86 mm, the diameter D3 of the head portion 10 is 6 mm or 9 mm, and the length L of the screw portion 30 is 6.6 mm.

As a result, the bone screw according to the present invention can be easily manufactured through a molding process and maintain constant strength. In particular, it is possible to provide tenting and shielding functions for the alveolar bone regenerated in a wider area while minimizing holes drilled in the alveolar bone. Advantageously, it is possible to improve stabilization of the bone tissue and a spacing capability of the alveolar bone.

The bone screws according to the present invention configured as described above are installed to a defected region of the alveolar bone in the lingual and apical directions while the gum is incised. Then, the bone graft B is filled, and they are covered with a membrane M. Then, the incised gum is sealed, and they are maintained therein for a certain period of time (see FIGS. 3 and 4).

During this period, the bone tissue is regenerated, and the alveolar bone is regenerated three-dimensionally through growth of the alveolar bone in the vertical and horizontal directions. Then, the bone screws according to the present invention are removed, and the implant is installed to the alveolar bone in the vertical direction.

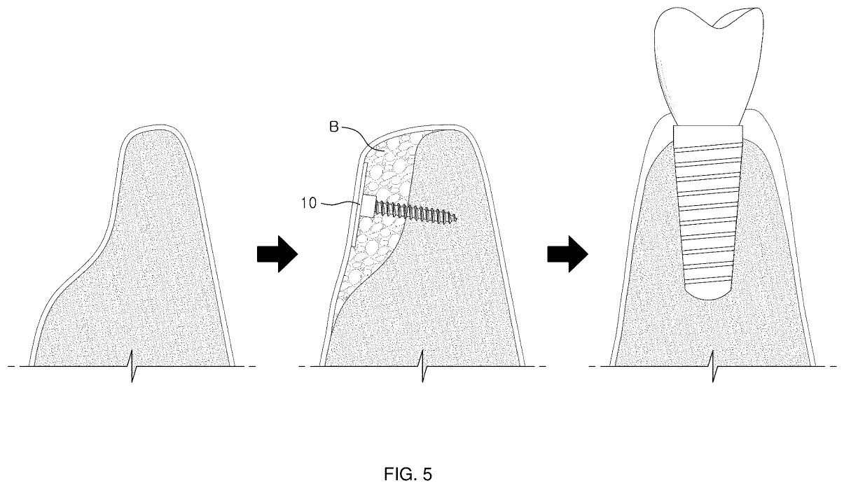

Meanwhile, using the bone screw according to the present invention, it is possible to effectively regenerate the alveolar bone through horizontal growth even when only the lateral side of the alveolar bone is defected as shown in FIG. 5. Therefore, it is possible to allow dentists to actively respond to various osteoinduction surgery conditions.

While embodiments of the invention have been described with reference to the drawings, a person skilled in the art would appreciate various modifications or changes without departing from the spirit and scope of the present invention, as set in the attached claims.

### INDUSTRIAL APPLICABILITY

The present invention relates to a bone screw for 3D guided bone regeneration, and can be widely applied to dental work-related industries.

What is claimed is:

1. A bone screw for 3D guided bone regeneration used in dental surgery for inducing and regenerating a part of alveolar bone defected in or around an implant surgery region, the bone screw comprising:
a head portion configured to provide a tenting function for a part of the alveolar bone to be regenerated or induced;
a neck portion formed on a lower surface of the head portion;
a screw portion formed beneath the neck portion and directly fixed to the alveolar bone in a thread fastening manner,
wherein the alveolar bone can be induced or regenerated three-dimensionally.

2. The bone screw according to claim 1, wherein the head portion has a plurality of blood holes.

3. The bone screw according to claim 1, wherein a ratio between an inner diameter (D1) of the screw portion and a diameter (D3) of the head portion is set to 1:4 to 1:6, and
a ratio between an outer diameter (D2) of the screw portion and a diameter (D3) of the head portion is set to 1:3 to 1:5.

4. The bone screw according to claim 1, wherein a wrench hole is provided at the center of the head portion.
